(19) United States
(12) Patent Application Publication
(10) Pub. No.: US 2022/0087239 A1
(43) Pub. Date: Mar. 24, 2022

(54) Variable Weight Cast-Mold Fishing Jig

(71) Applicant: Jonathan Polignani, New York, NY (US)

(72) Inventor: Jonathan Polignani, New York, NY (US)

(21) Appl. No.: 17/026,255

(22) Filed: Sep. 20, 2020

(51) Int. Cl. A01K 85/00; A01K 95/02; B22C 9/06; B22D 19/00

(52) U.S. Cl. CPC A01K 85/00; B22D 19/00; B22C 9/06; A01K 95/02

(57) ABSTRACT

This invention is a way of making a cast-mold jig used in angling that allows the angler to change the weight of the jig by adding and removing weights to and from the jig. FIGS. 1 and 2 illustrate two different ways of making a cast-mold jig that can accommodate removable weights. The example implementations depicted by FIGS. 1 and 2 show the embodiments of Claim 1 specifically with arrow items 1, 2, 11, 13. All other arrows are for contextual purposes.

### BACKGROUND OF THE INVENTION

Cast mold jigs are used by anglers to catch fish. A cast-mold jig is a singular weighted device which contains a hook, a heavy material that is cast onto the hook, and various embellishments. Different cast mold-jigs exist to match the preferences of the angler and the fishing conditions.

A cast-mold jig is created by setting a jig-hook in a casting mold. Then, a casting material such as lead is poured into the mold and left to set. When set, the resultant product is a jig, which consists of the jig-hook and the casting material which is now hardened and set around the jig-hook to be used as part of the permanently unified system called a jig. In its final stages of manufacture, a jig is typically embellished with adornments such as paint, false eyes, colorful fibers, trailers etc., to be used for attracting fish.

The jig-hook used in a cast-mold jig is different than other hooks used for angling since it needs to be attached to a fishing line but also accommodate having casting material around it. The casting material acts as a fixed weight attached firmly to the hook, and this type of jig is advantageous for various reasons in the activity of angling. Jig-hooks are common and sold by a variety of manufacturers.

The weight of the jig is an important factor in fishing. The fishing conditions such as the water depth, current speed as well as the angler's tackle and fishing preference vary. Discerning anglers choose the weight of their jig based on these conditions.

Currently, there is no way to vary the weight of this type of cast-mold jig. If the angler would like to use a jig of a different weight, he or she must carry an entirely different jig. This invention gives the angler the ability to change the weight of the jig that they are using, without having to carry or use a different jig, therefore broadening their fishing opportunities and reducing the need to carry additional jigs.

### BRIEF SUMMARY OF THE INVENTION

This invention is a variable weight cast-mold jig which is a novel type of cast-mold jig that can accommodate the addition and removal of weights, therefore allowing the angler to adjust the weight of the jig. Prior to this invention, once the jig is created, the weight of the jig is fixed and is determined by the amount of casting material poured into the mold. A variable weight cast-mold jig is different because it will allow the angler to change the weight of the jig at any time without having to use a different jig. This is advantageous because fishing conditions such as current, water depth and the tackle used are variable and small changes in the weight of the jig can be an advantage to the angler looking to modify their technique based on the varying conditions but still carry minimal equipment.

### DESCRIPTION OF THE INVENTION

A fishing hook is a device typically made of a strong metal wire and consists of several components which have relevance in the activity of angling. The tip of the wire is sharpened to pierce the fish, and a part of the wire is curved to hold onto the fish. A barb can be added to the end to keep the fish on the hook. A hook must also have a way of being attached to a fishing line: typically an eyelet is added to the hook for the purpose of attaching the hook to the fishing line. The size, shape, design and functions of hooks commonly vary depending on what type of fish is being targeted and how the hook is being used by the angler.

A jig-hook is a special type of hook which is used in a cast-mold to create a cast-mold jig. A cast mold jig adds a casting material as a weight directly to the jig-hook. The casting material forms what is known as the jig-head. The jig-hook and the weighted jig-head become a unified, fixed system in this type of jig.

A cast-mold jig is created by setting a jig-hook into a prefabricated mold. The mold must be customized so it capable of accepting the jig-hook that is desired to be used; there is typically a customized depression in the mold which matches the shape of the hook. The mold is also customized so the casting material takes on the desired shape to become the jig-head. Many designs for a jig mold exist, but they all must have a customized depression to accommodate the jig-hook being used and to produce the desired jig-head shape. The hook sits in this customized depression so that it does not move. Once the hook is positioned in the casting mold, the casting material is added and the mold is left to set. The casting material is usually lead. Once the casting material has set, the product is called a cast-mold jig which is a unified system consisting of a hook and the weighted material which has permanently set around part of the hook: the jig-hook and the jig-head.

When a jig is made as described above, the weight of the jig is fixed and determined largely in part by the amount of casting material used. Embellishments such as paint, false eyes and colorful fibers are added to the jig to create the final product which will be presented to the fish by the angler. These embellishments are not considered constituents of the final desired weight of the jig.

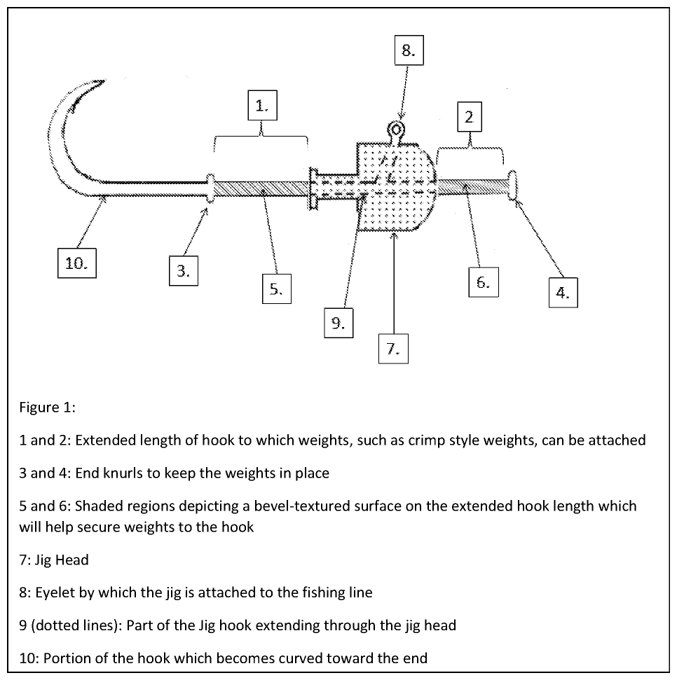

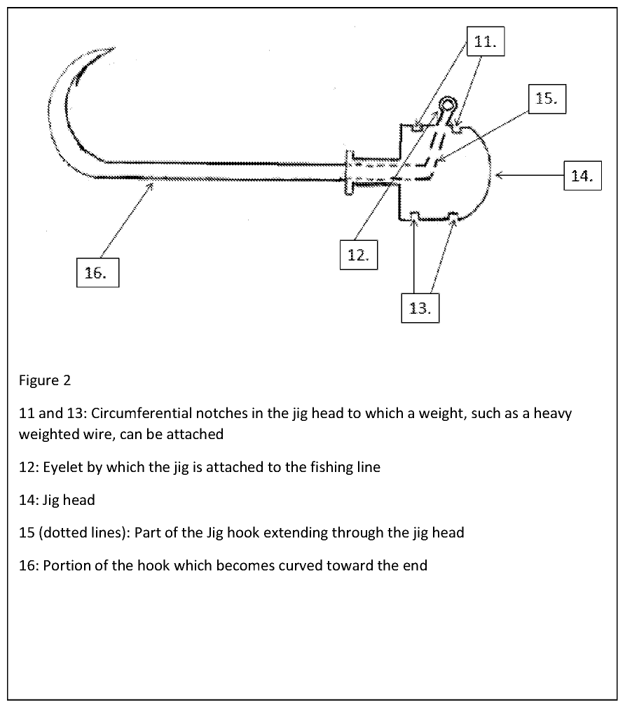

This new invention is called a variable weight cast-mold jig and if it is created using a cast-mold technique described above, it will produce a jig which allows the angler to vary the weight of the cast-mold jig even after the jig has been created and finished. FIGS. 1 and 2 describes the preferred design for the variable weight cast-mold jig, but the basic premise is simple: the jig-hook and/or the cast jig-head must have an attachment point or points on it which enable the angler to attach and remove weights.

Since the casting mold used to create this novel jig must be capable of accepting a novel jig-hook, the customized depression in the mold which accepts the hook is also novel. Additionally if the casting material is molded in such a way that it can accommodate removable weights, that is novel as well, therefore the customized depression which would form the casting material in such a manner is also novel.

Once the jig is created, the weights can be added. Examples of this implementation are: crimp style weights can be attached to the jig-hook if the jig-hook is designed to accept weights; a weighted wire weight can be added if the jig-head is designed to accept weights.

The angler can add and remove the weights as desired without removing the jig from the fishing line or having to carry additional jigs of different weights.

### DESCRIPTION OF THE ILLUSTRATIONS AND PREFERRED DESIGN OF INVENTION

FIG. 1: Claim 1 is implemented by designing a jig-hook with attachment points to accommodate removable weights such as crimp-style weights.
Items in FIG. 1 which facilitate the implementation of claim 1:
a. Extended lengths of hook in both directions from the jig along the central axis of the hook. These parts of the hook can be used as attachment points of a crimp-style weight.
b. A bevel-textured surface to help the weights stay attached and in a fixed position
c. An end bevel to help keep the weights in a fixed position on the hook

FIG. 2: Claim 1 is implemented by molding the casting material in a jig mold in such a way that the jig can accept removable weights such as a heavy-weighted wire, which can then be twisted or otherwise attached to the casting material

I claim:

1. Any part of a cast-mold jig which can be used to attach removable weights—excluding embellishments and adornments added to attract fish. Claim 1 is not limited to the preferred designs illustrated in FIGS. 1 and 2.

2. The design and implementation of the customized depression in a jig mold which allows the jig mold either to be capable of accepting and accommodating a jig-hook that implements claim 1 and/or to form the casting material into a shape which implements claim 1.
